(19) United States
(12) Patent Application Publication
(10) Pub. No.: US 2026/0111402 A1
(43) Pub. Date: Apr. 23, 2026

(54) DATA COMPLETION

(71) Applicant: BEIJING OCEANBASE TECHNOLOGY CO., LTD., Hangzhou (CN)

(72) Inventors: Jianyun SUN, Hangzhou (CN); Zhenjiang Xie, Hagzhou (CN)

(21) Appl. No.: 19/427,817

(22) Filed: Dec. 19, 2025

Related U.S. Application Data
(63) Continuation of application No. PCT/CN2024/127880, filed on Oct. 28, 2024.

(30) Foreign Application Priority Data
Nov. 22, 2023 (CN) 202311569370.2

(51) Int. Cl. G06F 16/22

(52) U.S. Cl. CPC G06F 16/221

(57) ABSTRACT

The present application relates to the field of database technologies, and for example provides a data completion method and apparatus, an electronic device, and a storage medium. A data completion method includes: performing area division on a target table to be processed based on a primary key column in the target table to obtain at least one target area; determining a number of rows in each of the at least one target area; determining a starting row offset value of each target area based on the number of rows corresponding to each of the at least one target area; and writing data of each target column group of at least one target column group in the target table and in each target area to a baseline sorted string table corresponding to the target column group based on the starting row offset value of each target area. As such, it is not necessary to create corresponding column indexes for all columns separately, nor to sort data of each column through the column index, thereby simplifying the cumbersome steps of data completion and reducing consumption of system resources and time costs.

### TECHNICAL FIELD

The present application relates to the field of database technologies, and for example, relates to a data completion method and apparatus, an electronic device, and a storage medium.

### BACKGROUND

In practice, to support different types of services, several columns in a table are usually grouped to obtain a column group (CG) based on service requirements. In a same table, one or more CGs can be configured. When executing data definition language (DDL) on a table, a plurality of CGs usually need to be updated. For example, a process of writing updated data of each CG to a corresponding baseline sorted string table (SSTable) is referred to as data completion.

In the existing technologies, a column index is usually created for each column in a table, so that data completion can be performed on a CG based on the column indexes.

### SUMMARY

The implementations of the present application provide a data completion method and apparatus, an electronic device, and a storage medium, which, among others, reduce consumption of system resources during data completion.

In an aspect, an implementation of the present application provides a data completion method, including: performing area division on a target table to be processed based on a primary key column in the target table to obtain at least one target area; determining a number of rows in each of the at least one target area; determining a starting row offset value of each target area based on the number of rows corresponding to each of the at least one target area, the starting row offset value being used to locate the target area; and writing data of each target column group of at least one target column group in the target table and in each target area to a baseline sorted string table corresponding to the target column group based on the starting row offset value of each target area.

In an implementation, the performing area division on the target table to be processed based on the primary key column in the target table to obtain the at least one target area includes: sampling data in the primary key column, the data in the primary key column being sequentially sorted; comparing adjacent sample values among sample values respectively to obtain corresponding comparison results; determining at least one data division row based on the comparison results; and dividing the target table based on the at least one data division row to obtain the at least one target area.

In an implementation, the determining the starting row offset value of each target area based on the number of rows corresponding to each of the at least one target area includes: performing following steps for each target area in an order of the at least one target area from top to bottom in the target table: in response to the target area being a first area, determining that the starting row offset value of the target area is a starting value; and in response to the target area being not the first area, determining the starting row offset value of the target area based on a number of rows corresponding to each of all target areas before the target area and the starting value.

In an implementation, the writing the data of each target column group of the at least one target column group in the target table and in each target area to the baseline sorted string table corresponding to the target column group based on the starting row offset value of each target area includes: performing following steps for each target area by using a thread corresponding to the target area: determining a number of the at least one target column group as an initial batch size; writing the data of each target column group of the at least one target column group and in the target area to the corresponding baseline sorted string table based on the starting row offset value of the target area and the batch size; in response to determining that data writing fails, obtaining a latest successful count of target column groups whose data is successfully written currently; determining a new batch size based on the batch size and the latest successful count; and performing a data writing operation on a target column group whose data is not successfully written based on the new batch size.

In an implementation, the performing the data writing operation on the target column groups whose data is not successfully written based on the new batch size includes: iteratively performing following steps until it is determined that data writing is successful and there is no target column group whose data is not successfully written: writing data of a remaining target column group and in the target area to the corresponding baseline sorted string table based on the starting row offset value of the target area and the new batch size, the remaining target column group being a target column group whose data is not successfully written currently; in response to determining that data writing fails, obtaining a latest successful count of target column groups whose data is successfully written currently, and determining a new batch size based on the batch size and the latest successful count; in response to determining that data writing is successful and there is a target column group whose data is not successfully written, updating the new batch size based on a ratio; and in response to determining that data writing is successful and there is no target column group whose data is not successfully written, determining that a data completion procedure is ended.

In an implementation, the determining the new batch size based on the batch size and the latest successful count includes: determining a product of the batch size and a weight; and determining a greatest value between the product and the latest successful count as the new batch size.

In an implementation, the method further includes: in response to determining that data writing fails, obtaining a sum of batch sizes corresponding to all threads; and in response to the sum being not greater than a number of the threads, determining that a memory resource is insufficient, and ending a data completion procedure.

In an aspect, an implementation of the present application provides a data completion apparatus, including: a dividing unit, configured to perform area division on a target table to be processed based on a primary key column in the target table to obtain at least one target area; a determining unit, configured to determine a number of rows in each of the at least one target area; a locating unit, configured to determine a starting row offset value of each target area based on the number of rows corresponding to each of the at least one target area, the starting row offset value being used to locate the target area; and a writing unit, configured to write data of each target column group of at least one target column group in the target table and in each target area to a baseline sorted string table corresponding to the target column group based on the starting row offset value of each target area.

In an implementation, the dividing unit is configured to: sample data in the primary key column, the data in the primary key column being sequentially sorted; compare adjacent sample values among sample values respectively to obtain corresponding comparison results; determine at least one data division row based on the comparison results; and divide the target table based on the at least one data division row to obtain the at least one target area.

In an implementation, the locating unit is configured to: perform following steps for each target area in an order of the at least one target area from top to bottom in the target table: in response to the target area being a first area, determining that the starting row offset value of the target area is a starting value; and in response to the target area being not the first area, determining the starting row offset value of the target area based on a number of rows corresponding to each of all target areas before the target area and the starting value.

In an implementation, the writing unit is configured to: perform following steps for each target area by using a thread corresponding to the target area: determining a number of the at least one target column group as an initial batch size; writing the data of each target column group of the at least one target column group and in the target area to the corresponding baseline sorted string table based on the starting row offset value of the target area and the batch size; in response to determining that data writing fails, obtaining a latest successful count of target column groups whose data is successfully written currently; determining a new batch size based on the batch size and the latest successful count; and performing a data writing operation on a target column group whose data is not successfully written based on the new batch size.

In an implementation, the writing unit is configured to: iteratively perform following steps until it is determined that data writing is successful and there is no target column group whose data is not successfully written: writing data of a remaining target column group and in the target area to the corresponding baseline sorted string table based on the starting row offset value of the target area and the new batch size, the remaining target column group being a target column group whose data is not successfully written currently; in response to determining that data writing fails, obtaining a latest successful count of target column groups whose data is successfully written currently, and determining a new batch size based on the batch size and the latest successful count; in response to determining that data writing is successful and there is a target column group whose data is not successfully written, updating the new batch size based on a ratio; and in response to determining that data writing is successful and there is no target column group whose data is not successfully written, determining that a data completion procedure is ended.

In an implementation, the writing unit is configured to: determine a product of the batch size and a weight; and determine a greatest value between the product and the latest successful count as the new batch size.

In an implementation, the writing unit is further configured to: in response to determining that data writing fails, obtain a sum of batch sizes corresponding to all threads; and in response to the sum being not greater than a number of the threads, determine that a memory resource is insufficient, and end the data completion procedure.

In an aspect, an implementation of the present application provides an electronic device. The electronic device includes a processor; and a memory storing computer instructions. The computer instructions are used to enable the processor to perform the steps of the method provided in any of the optional implementations of data completion described above.

In an aspect, an implementation of the present application provides a storage medium storing computer instructions. The computer instructions are used to enable a computer to perform the steps of the method provided in any of the optional implementations of data completion described above.

In the data completion method and apparatus, the electronic device, and the storage medium provided by the implementations of the present application, area division is performed on a target table to be processed based on a primary key column in the target table to obtain at least one target area; a number of rows in each of the at least one target area is determined; a starting row offset value of each target area is determined based on the number of rows corresponding to each of the at least one target area, the starting row offset value being used to locate the target area; and data of each target column group of at least one target column group in the target table and in each target area is written to a baseline sorted string table corresponding to the target column group based on the starting row offset value of each target area. As such, by performing area division on the table through the primary key column and locating data of each area through an offset of a starting row of each area, it is not necessary to create corresponding column indexes for all columns separately, nor to sort data of each column through the column indexes, thereby simplifying the cumbersome steps of data completion and reducing consumption of system resources and time costs.

### BRIEF DESCRIPTION OF DRAWINGS

To describe the technical solutions in example implementations of the present application or in the existing technologies more clearly, the following is a brief introduction of the accompanying drawings required for describing the example implementations or the existing technologies. Clearly, the accompanying drawings described below are merely some implementations of the present application, and a person of ordinary skill in the art can derive other drawings from such accompanying drawings without making innovative efforts.

FIG. 1 is a flowchart illustrating a data completion method according to an implementation of the present application;

FIG. 2 is an example diagram illustrating determining a starting row offset value according to an implementation of the present application;

FIG. 3 is an example diagram illustrating a method for adaptive adjustment of a batch size according to an implementation of the present application;

FIG. 4 is a block diagram illustrating a structure of a data completion apparatus according to an implementation of the present application; and

FIG. 5 is a schematic structural diagram illustrating an electronic device according to an implementation of the present application.

### DESCRIPTION OF EMBODIMENTS

The technical solutions in the present application are clearly and completely described below with reference to the accompanying drawings. Clearly, the described implementations are some but not all of the implementations of the present application. Based on the implementations of the present application, all other implementations obtained by a person of ordinary skill in the art without making innovative efforts fall within the protection scope of the present application. In addition, the technical features involved in different implementations of the present application described below can be combined with each other as long as they do not conflict with each other.

First, some terms involved in the implementations of the present application are explained for understanding by a person skilled in the art.

Terminal device: it can be a mobile terminal, a fixed terminal, or a portable terminal, e.g., a mobile phone, a station, a unit, a device, a multimedia computer, a multimedia tablet, an internet node, a communicator, a desktop computer, a laptop computer, a notebook computer, a netbook computer, a tablet computer, a personal communication system device, a personal navigation device, a personal digital assistant, an audio/video player, a digital camera/camcorder, a positioning device, a television receiver, a radio broadcast receiver, an e-book device, a game device, or any combination thereof, including accessories and peripherals of these devices or any combination thereof. It is also contemplated that terminal devices can support any type of interface (e.g., wearable devices) for users, etc.

Server: it can be an independent physical server, or can be a server cluster or a distributed system including a plurality of physical servers, or can be a cloud server that provides a basic cloud computing service such as a cloud service, a cloud database, cloud computing, a cloud function, cloud storage, a network service, cloud communication, a middleware service, a domain name service, a security service or a big data and artificial intelligence platform.

Distributed relational database (e.g., one of OceanBase, OB): It is a distributed relational database that is continuously available, and has characteristics of scalability and high performance.

Online transaction processing (OLTP): it generally refers to transaction operations involving a small number of rows and short duration, e.g., banking transactions.

On-line analysis processing (OLAP): it generally refers to complex data analysis involving a large number of rows and long duration, e.g., report statistics.

Log structured merge tree (LSM Tree): a data storage structure composed of a plurality of layers of independent data structures.

Baseline SSTable: it is a data structure in an LSM Tree that is persisted on a disk and is composed of a plurality of macro blocks.

Macroblock: it includes a plurality of rows of sorted data, is persisted on a disk, can have a fixed size of 2M, and is composed of a plurality of microblocks.

Microblock: it is the basic unit of a macroblock, includes a plurality of rows of sorted data, is persisted on a disk. The size of a microblock is not fixed, usually several KB, and the microblock is the smallest unit for reading SSTable data from the disk.

The technical concept of the present application is described below.

In some database scenarios, to support different types of services (e.g., OLTP and OLAP services), some databases (e.g., OBs) have developed a columnar storage table function, which allows users to specify several column groups (CGs) in a same table.

For example, the following statement can be used to set the CGs: create table t1(c1 int primary key, c2 varchar(256), c3 int) with column group (all columns, each column). This represents creation of table 1 with CGs. In terms of data organization at a storage layer, table 1 has four CGs, which are sequentially as follows: (c1, c2, c3), (c1), (c2), and (c3). Data of each CG is organized as an SSTable. That is, the data of each CG is actually stored in the corresponding SSTable.

When executing DDL on a table, data completion usually needs to be performed on a plurality of CGs. For example, when executing "alter table t1 modify column c2 int" on the above table 1, data completion needs to be performed on the two CGs (c1, c2, c3) and (c2).

In the traditional technologies, column indexes are usually created for all columns when a table is created. If column indexes are not created when the table is created, column indexes are created through a BUILD procedure when indexes need to be created.

However, creating a column index for each column and performing sorting based on column data consumes a large quantity of system resources. In addition, when the BUILD procedure creates column indexes one by one, main table data needs to be scanned multiple times, resulting in significant Input/Output (I/O) overhead and relatively long build time.

Implementations of the present application provide data completion methods and apparatuses, electronic devices, and storage media, which, among others, reduce consumption of system resources during data completion.

An implementation of the present application provides a data completion method. The method can be applied to an electronic device. The present application is not limited by a type of the electronic device, which can be any type of device suitable for implementation, such as a terminal device or a server. Details are omitted herein for simplicity. In an application scenario, the implementation of the present application can be applied to an OB. When executing DDL on a target table, target column groups that are in the target table and that require data reorganization are determined, and area division is performed based on a primary key column in the target table. Based on an offset of a starting row of each target area, data in the target area is located. Then, based on the offset corresponding to each target area, data of each target column group and in the target area is written to an SSTable corresponding to each target column group, thereby implementing data completion.

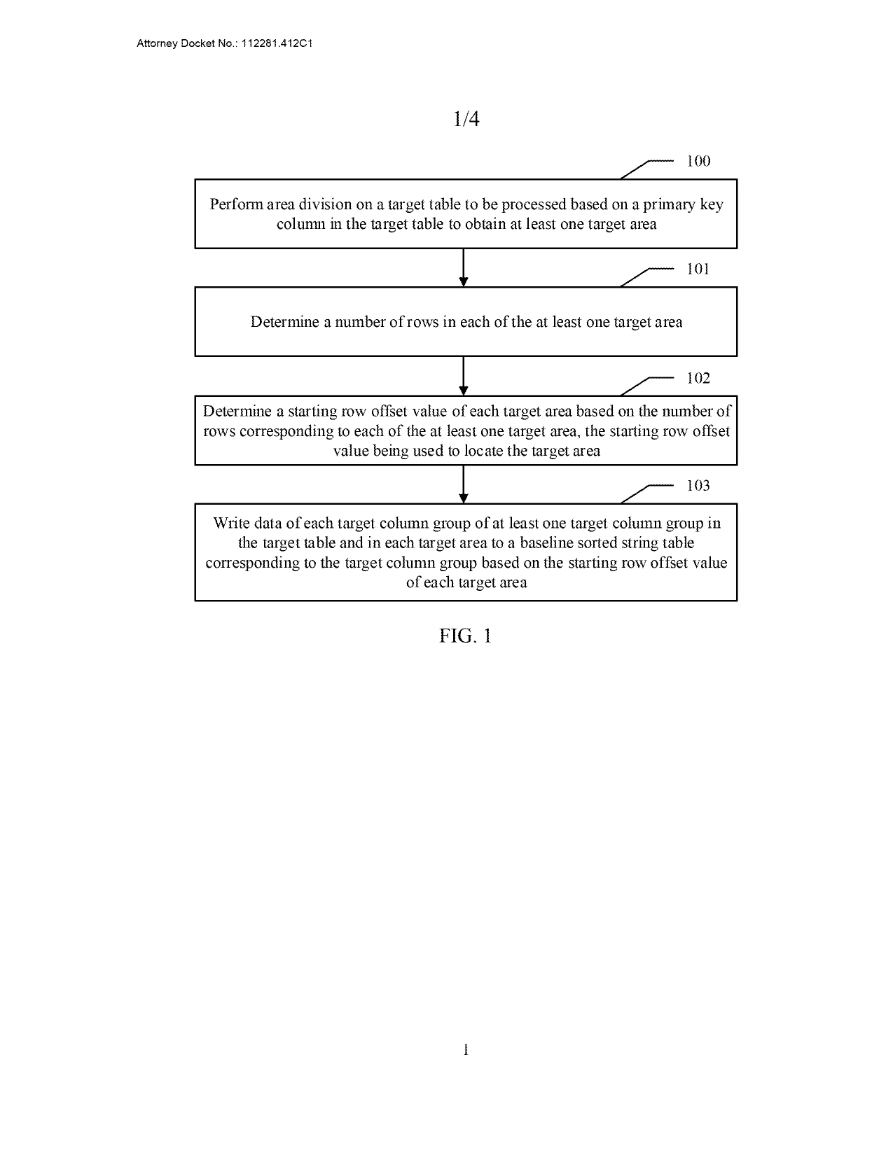

Referring to FIG. 1, which is a flowchart illustrating a data completion method according to an implementation of the present application, applied to an electronic device. The method is described below with reference to FIG. 1, and an example implementation procedure of the method is as follows.

Step 100: Perform area division on a target table to be processed based on a primary key column in the target table to obtain at least one target area.

In an implementation, when step 100 is performed, following steps can be used.

S1001: Sample data in the primary key column to obtain a plurality of sample values.

In an implementation, a primary key of the target table is set, the primary key column in the target table is determined, data in the primary key column is sorted, and when it is determined that data completion (executing DDL on the target table) is needed, the data in the primary key column is sampled based on a sampling interval to obtain a plurality of sample values.

The primary key is used to uniquely identify a record (i.e., a row of data). Primary key values cannot be duplicated and are not allowed to be null. In the implementations of the present application, the data in the primary key column is sequentially sorted. The sampling interval can be a fixed value or a non-fixed value (for example, can be continuously incremented). In practice, the sampling interval can be set based on an actual application scenario, for example, the sampling interval is 5. No limitation is imposed herein.

DDL is used to define relational schemas, delete relations, modify relational schemas, and create various objects in a database. The objects in the database can be tables, clusters, indexes, views, functions, stored procedures, triggers, etc.

S1002: Compare adjacent sample values among the sample values respectively to obtain corresponding comparison results.

In an implementation, the sample values are all numerical values. The following step is performed for each sample value in an order of the sample values in the primary key column: determining a difference between the sample value and a previous sample value as the comparison result.

S1003: Determine at least one data division row based on the comparison results.

As an example, if the difference between a sample value and a previous sample value is greater than a threshold difference (e.g., 5), a row where the sample value is located is determined as a data division row.

In practice, the threshold difference can be set based on an actual application scenario. No limitation is imposed herein.

S1004: Divide the target table based on the at least one data division row to obtain the at least one target area.

As such, the table can be divided into a plurality of target areas.

Step 101: Determine a number of rows in each of the at least one target area.

In an implementation, a thread is assigned to each target area, and data of each target area is shuffled to the corresponding thread. Each thread determines the received number of rows in the target area. It should be noted that the number of rows in different target areas can be the same or different. For example, the number of rows in a target area is 10, and the number of rows in another target area is 20.

In some implementations, each thread can correspond to one or more target areas. The threads can be located on a same device or located on different devices. No limitation is imposed herein.

As such, the target areas can be processed in parallel by using a plurality of threads, thereby improving data processing efficiency.

Step 102: Determine a starting row offset value of each target area based on the number of rows corresponding to each of the at least one target area.

The starting row offset value is used to locate the target area. In an implementation, following steps are performed for each target area in an order of the at least one target area from top to bottom in the target table.

If a target area is a first area, it is determined that the starting row offset value of the target area is a starting value. As an example, the starting value can be 0.

If the target area is not the first area, the starting row offset value of the target area is determined based on a number of rows corresponding to each of all target areas before the target area and the starting value.

As an example, if the starting value is 0, the number of rows in the first area in the target table is 10, and the number of rows in the second target area is 15, the starting row offset value of the third target area is 0 + 10 + 15 = 25.

As another example, each thread counts the number of rows in the corresponding target area. A thread obtains a statistical result of each of other threads, determines the starting row offset value of each target area based on the statistical result of each thread, and shuffles the starting row offset value of each target area to a thread corresponding to the corresponding target area.

In some implementations, the thread can be a certain pre-specified thread, any randomly selected thread, or the last thread that completes counting of the number of rows. In practice, the thread can be determined based on an actual application scenario. No limitation is imposed herein.

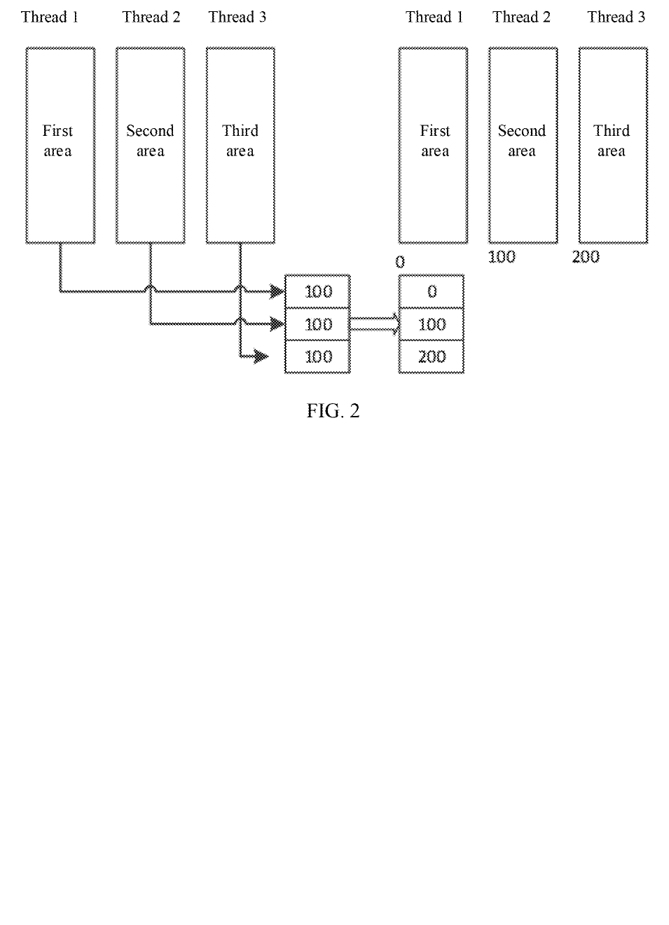

Referring to FIG. 2, which is an example diagram illustrating determining a starting row offset value. In FIG. 2, thread 1, thread 2, and thread 3 count the number of rows in each of target areas (i.e., a first area, a second area, and a third area) respectively corresponding to thread 1, thread 2, and thread 3. If it is determined that the number of rows in each of the at least one target area is 100, it is determined that the starting row offset value of the first area is 0, the starting row offset value of the second area is 100, and the starting row offset value of the third area is 200.

Because CGs of non-primary key columns need to identify each data row, in the implementations of the present application, the starting row offset value of each target area is determined by accumulating the number of rows in each of the at least one target area. This process can be referred to as row count, so that each data row in each target area can be identified based on the starting row offset value of each target area, thereby facilitating subsequent data completion. It is not necessary to establish a column index for each column, thereby simplifying a cumbersome operation, reducing system overhead, and improving data processing efficiency.

Step 103: Write data of each target column group of at least one target column group in the target table and in each target area to a baseline sorted string table corresponding to the target column group based on the starting row offset value of each target area.

In an implementation, following steps are performed for each target area by using a thread corresponding to the target area.

S1031: Determine a number of the at least one target column group as an initial batch size.

In an implementation, a number of target CGs to be processed in the target table (i.e., the number of groups) is obtained, and the number of groups is determined as the initial batch size (batch_size).

As an example, if the target table includes four CGs, it is determined that the initial batch_size is 4.

A CG is a group of a plurality of columns in a table. A target CG is a CG among the CGs that requires data reorganization.

S1032: Write data of each target column group of the at least one target column group and in the target area to the corresponding baseline sorted string table based on the starting row offset value of the target area and the batch size.

As an example, the target CGs include a first CG and a second CG. If the first CG is column C2, and the second CG is column C3 and column C4, the number of the target CGs is 2, and the batch size is 2. The thread writes data of column C2 and in the target area to a first baseline SSTable corresponding to the first CG, and writes data of column C3 and column C4 and in the target area to a second baseline SSTable corresponding to the second CG.

S1033: If it is determined that data writing fails, obtain a latest successful count of target column groups whose data is successfully written currently.

It should be noted that due to memory resource limitations, data of each target CG may not be completely successfully written to the corresponding baseline SSTable. However, data of some target CGs may be successfully written to the corresponding baseline SSTables. Therefore, when it is determined that data writing fails, a number of the target CGs (i.e., the target CGs whose data is successfully written currently) is obtained as the latest successful count.

As an example, if the batch size is 4, three target CGs are successfully written, and one target CG fails to be written, it is determined that the latest successful count is 3.

Further, if it is determined that data writing is successful and that data in each target CG has been successfully written to the corresponding baseline SSTable, it is determined that the data has been completed, and a data completion procedure is ended.

S1034: Determine a new batch size based on the batch size and the latest successful count.

In an implementation, a product of the batch size and a weight is determined; and a greatest value between the product and the latest successful count as the new batch size.

A value range of the weight is (0, 1].

As an example, the weight can be 0.5. In practice, the weight can be set based on an actual application scenario. No limitation is imposed herein.

As such, if data fails to be written, the batch size can be reduced through the weight.

S1035: Perform a data writing operation on a target column group whose data is not successfully written based on the new batch size.

In an implementation, when S1035 is performed, following steps can be iteratively performed until it is determined that data writing is successful and there is no target column group whose data is not successfully written.

S1035-1: Write data of a remaining target column group and in the target area to the corresponding baseline sorted string table based on the starting row offset value of the target area and the new batch size, and perform any one of S1035-2, S1035-3, and S1035-4.

The remaining target column group is a target column group whose data is not successfully written currently.

As an example, the target CGs include a first CG, a second CG, and a third CG. If both the second CG and the third CG are successfully written, and the first CG fails to be written, the first CG is the remaining target CG. Because the first CG only includes column C2, data of column C2 and in the target area is written to a first baseline SSTable corresponding to the first CG.

S1035-2: If it is determined that data writing fails, obtain a latest successful count of target column groups whose data is successfully written currently, determine a new batch size based on the batch size and the latest successful count, and perform S1035-1.

For example, for steps in a process of performing S1035-3, references can be made to S1033 and S1034. Details are omitted herein for simplicity.

S1035-3: If it is determined that data writing is successful and there is a target column group whose data is not successfully written, update the new batch size based on a ratio, and perform S1035-1.

The ratio can be not less than 1, for example, the ratio is 2.

As an example, if it is determined that data writing is successful and there is a target column group whose data is not successfully written, use a product of a current batch size (i.e., the new batch size) and the ratio as the new batch size. In practice, the ratio can be set based on an actual application scenario. No limitation is imposed herein.

The target column group whose data is not successfully written refers to a target column group whose data in the target area is not successfully written to the corresponding baseline SSTable.

S1035-4: If it is determined that data writing is successful and there is no target column group whose data is not successfully written, determine that the data completion procedure is ended.

Further, in a data completion process, when it is determined that data writing fails, a sum of batch sizes corresponding to all threads can be obtained. If the sum is not greater than a number of the threads, it is determined that a memory resource is insufficient, and the data completion procedure is ended.

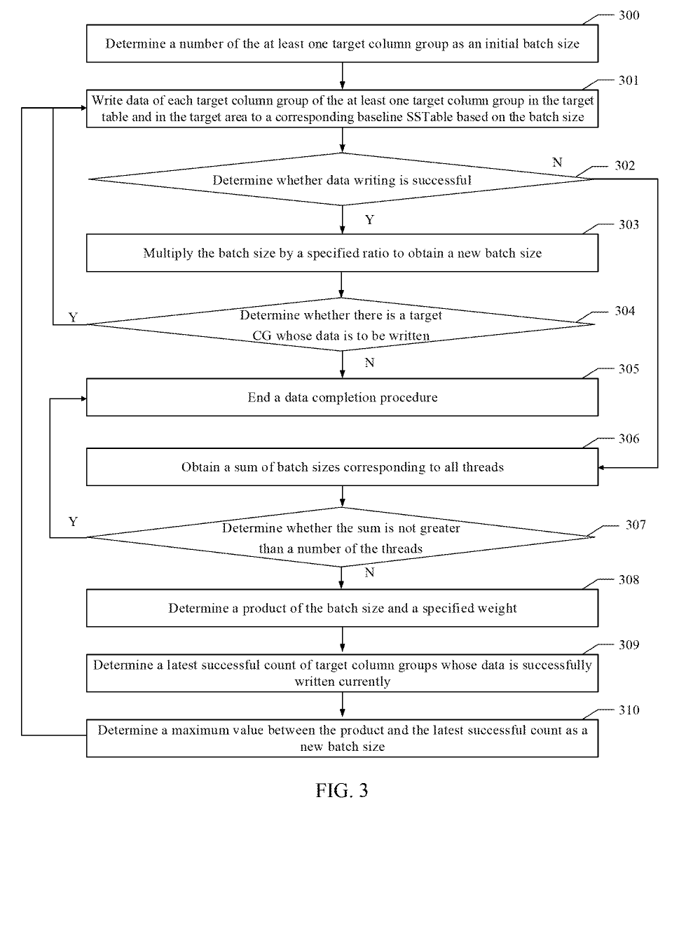

The following uses an example in which a thread performs data completion on a target area to describe the above implementation. Referring to FIG. 3, which is an example diagram illustrating a method for adaptive adjustment of a batch size according to an implementation of the present application. An example implementation procedure of the method can include following steps.

Step 300: Determine a number of at least one target column group as an initial batch size.

Step 301: Write data of each target column group of the at least one target column group and in the target area to a corresponding baseline SSTable based on the batch size.

Step 302: Determine whether data writing is successful, if yes, perform step 303, otherwise, perform step 306.

Step 303: Multiply the batch size by a ratio to obtain a new batch size.

Step 304: Determine whether there is a target CG whose data is to be written, if yes, perform step 301, otherwise, perform step 305.

The target CG whose data is to be written refers to a CG whose data in the target area is to be written to the corresponding baseline SSTable.

Step 305: End a data completion procedure.

Step 306: Obtain a sum of batch sizes corresponding to all threads.

Step 307: Determine whether the sum is not greater than a number of the threads, if yes, perform step 305, otherwise, perform step 308.

Step 308: Determine a product of the batch size and a weight.

Step 309: Determine a latest successful count of target column groups whose data is successfully written currently.

Step 310: Determine a greatest value between the product and the latest successful count as a new batch size, and perform step 301.

For example, for steps of step 300 to step 310, references can be made to the above step 100 to step 103. Details are omitted herein for simplicity.

It should be noted that a process of writing each row of data of the target CG and in the corresponding target area to the corresponding baseline SSTable by using a thread can be referred to as rescan. Because a buffer of at least the macroblock size (e.g., 2M) needs to be maintained, in scenarios with smaller memory specifications, to avoid memory exhaustion, sorted data needs to be scanned multiple times. In scenarios with larger memory specifications, it is desirable to minimize a number of scans to save disk I/O overhead. The maximum number of columns in a table can be 4096. Because the memory consumption of a data completion link is difficult to accurately reserve, to reduce overhead, some strategies (e.g., a greedy algorithm) can be used for data completion. For example, a number N (N is a positive integer) of all target CGs can first be used as a batch_size, and rescan is performed based on the batch_size. If it is determined that data writing is successful, only one rescan is needed. If it is determined that data writing fails, a latest successful count last_succ_cg_count of CGs whose data is successfully written and a latest batch size last_batch_size are obtained, and it is determined that batch_size = max(last_batch_size/2, last_succ_cg_count, 1). Further, if a sum of the batch_sizes of all threads is less than or equal to the number of threads, it indicates that a memory resource is severely insufficient, no retry is performed, and the procedure returns failure and exits.

In the implementations of the present application, it is not necessary to establish a column index for each column. Only a primary key needs to be set, thereby saving a lot of computation overhead. In addition, because an SSTable corresponding to a CG follows a row order of the primary key, a row offset is used to locate a row of a main table without redundantly storing a primary key value, thereby saving storage overhead of the primary key value. Further, in a batched manner, data of a plurality of CGs can be completed in one data scan, thereby greatly saving construction overhead of columnar storage. In addition, the batch_size can be adaptively adjusted, thereby further reducing the number of rescans, greatly reducing system overhead and time costs, and improving data processing efficiency and data completion performance.

User information (including but not limited to a device information of a user, personal information of a user, etc.) and data (including but not limited to data used for analysis, stored data, displayed data, etc.) used in the present application are information and data that are authorized by the user or fully authorized by each party, related data needs to be collected, used, and processed by abiding by related laws and regulations and standards of a related country and region, and a corresponding operation entry is provided, so that the user chooses to perform authorization or rejection.

Based on the same inventive concept, an implementation of the present application further provides a data completion apparatus. Because the problem solving principle of the above apparatus and device is similar to that of the data completion method, for the implementation of the above apparatus, references can be made to the implementation of the method, and details are omitted herein for simplicity. The apparatus can be applied to an electronic device. The present application is not limited by a type of the electronic device, which can be any type of device suitable for implementation, such as a smartphone or a tablet computer. Details are omitted herein for simplicity.

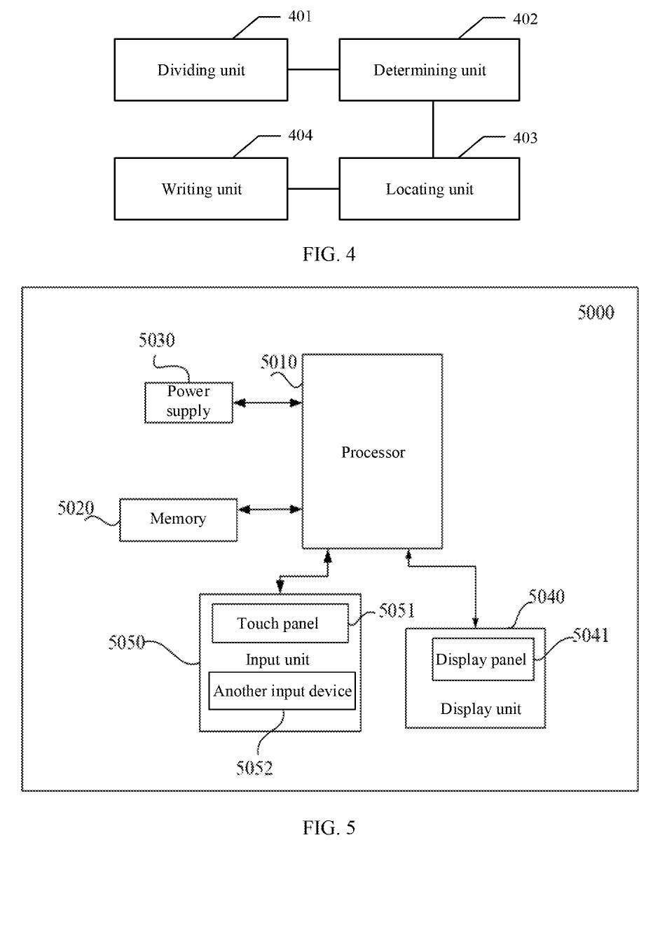

Referring to FIG. 4, which is a block diagram illustrating a structure of a data completion apparatus according to an implementation of the present application. In some implementations, the example data completion apparatus of the present application includes: a dividing unit 401, configured to perform area division on a target table to be processed based on a primary key column in the target table to obtain at least one target area; a determining unit 402, configured to determine a number of rows in each of the at least one target area; a locating unit 403, configured to determine a starting row offset value of each target area based on the number of rows corresponding to each of the at least one target area, the starting row offset value being used to locate the target area; and a writing unit 404, configured to write data of each target column group of at least one target column group in the target table and in each target area to a baseline sorted string table corresponding to the target column group based on the starting row offset value of each target area.

In an implementation, the dividing unit 401 is configured to: sample data in the primary key column, the data in the primary key column being sequentially sorted; compare adjacent sample values among sample values respectively to obtain corresponding comparison results; determine at least one data division row based on the comparison results; and divide the target table based on the at least one data division row to obtain the at least one target area.

In an implementation, the locating unit 403 is configured to: perform following steps for each target area in an order of the at least one target area from top to bottom in the target table: if the target area is a first area, determining that the starting row offset value of the target area is a starting value; and if the target area is not the first area, determining the starting row offset value of the target area based on a number of rows corresponding to each of all target areas before the target area and the starting value.

In an implementation, the writing unit 404 is configured to: perform following steps for each target area by using a thread corresponding to the target area: determining a number of at least one target column group as an initial batch size; writing data of each target column group of the at least one target column group and in the target area to the corresponding baseline sorted string table based on the starting row offset value of the target area and the batch size; if it is determined that data writing fails, obtaining a latest successful count of target column groups whose data is successfully written currently; determining a new batch size based on the batch size and the latest successful count; and performing a data writing operation on a target column group whose data is not successfully written based on the new batch size.

In an implementation, the writing unit 404 is configured to: iteratively perform following steps until it is determined that data writing is successful and there is no target column group whose data is not successfully written: writing data of a remaining target column group and in the target area to the corresponding baseline sorted string table based on the starting row offset value of the target area and the new batch size, the remaining target column group being a target column group whose data is not successfully written currently; if it is determined that data writing fails, obtaining a latest successful count of target column groups whose data is successfully written currently, and determining a new batch size based on the batch size and the latest successful count; if it is determined that data writing is successful and there is a target column group whose data is not successfully written, updating the new batch size based on a ratio; and if it is determined that data writing is successful and there is no target column group whose data is not successfully written, determining that a data completion procedure is ended.

In an implementation, the writing unit 404 is configured to: determine a product of the batch size and a weight; and determine a greatest value between the product and the latest successful count as the new batch size.

In an implementation, the writing unit 404 is further configured to: obtain a sum of batch sizes corresponding to all threads if it is determined that data writing fails; and determine that a memory resource is insufficient, and end the data completion procedure if the sum is not greater than the number of the threads.

In an aspect, an implementation of the present application provides an electronic device. The electronic device includes a processor; and a memory storing computer instructions. The computer instructions are used to enable the processor to perform the steps of the method provided in any of the optional implementations of data completion described above.

In an aspect, an implementation of the present application provides a storage medium storing computer instructions. The computer instructions are used to enable a computer to perform the steps of the method provided in any of the optional implementations of data completion described above.

In the data completion method and apparatus, the electronic device, and the storage medium provided by the implementations of the present application, area division is performed on a target table to be processed based on a primary key column in the target table to obtain at least one target area; a number of rows in each of the at least one target area is determined; a starting row offset value of each target area is determined based on the number of rows corresponding to each of the at least one target area, the starting row offset value being used to locate the target area; and data of each target column group of at least one target column group in the target table and in each target area is written to a baseline sorted string table corresponding to the target column group based on the starting row offset value of each target area. As such, by performing area division on the table through the primary key column and locating data of each area through an offset of a starting row of each area, it is not necessary to create corresponding column indexes for all columns separately, nor to sort data of each column through the column indexes, thereby simplifying the cumbersome steps of data completion and reducing consumption of system resources and time costs.

An implementation of the present application provides an electronic device. The electronic device includes a processor; and a memory storing computer instructions. The computer instructions are used to enable the processor to perform the method in any of the above implementations described above.

An implementation of the present application provides a storage medium storing computer instructions. The computer instructions are used to enable a computer to perform the method in any of the above implementations described above.

FIG. 5 is a schematic structural diagram illustrating an electronic device 5000. Referring to FIG. 5, the electronic device 5000 includes one or more processor 5010 and one or more memory 5020. In some implementations, the electronic device 5000 can further include a power supply 5030, a display unit 5040, and an input unit 5050. The one or more processors may be configured to individually or collectively conduct actions to implement the methods provided herein.

When the one or more processors 5010 collectively conduct actions, they may or may not conduct the same action or same part of an action at a same time and they may conduct different actions or different parts of an action collectively.

The one or more memory devices 5020 may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The processor 5010 is a control center of the electronic device 5000, connects all components through various interfaces and lines, and performs various functions of the electronic device 5000 by running or executing software programs and/or data stored in the memory 5020.

In the implementations of the present application, the processor 5010, when invoking a computer program stored in the memory 5020, performs the steps in the above implementations.

In some implementations, the processor 5010 can include one or more processing units. Preferably, the processor 5010 can integrate an application processor and a modem processor. The application processor mainly processes an operating system, a user interface, an application, etc. The modem processor mainly processes wireless communication. It can be understood that the above modem processor may not be integrated into the processor 5010. In some implementations, the processor and the memory can be implemented on a single chip. In some implementations, the processor and the memory can alternatively be implemented on separate chips respectively.

The memory 5020 can mainly include a program storage area and a data storage area. The program storage area can store an operating system, various applications, etc. The data storage area may store data created based on the use of the electronic device 5000. In addition, the memory 5020 can include a high-speed random access memory, or can further include a non-volatile memory, e.g., at least one disk memory device, a flash memory device, or another non-volatile solid state memory device.

The electronic device 5000 further includes a power supply 5030 (e.g., a battery) that supplies power to various components. The power supply can be logically connected to the processor 5010 through a power management system to manage charging, discharging, power consumption, and other functions through the power management system.

The display unit 5040 can be used to display information input by a user or information provided to the user and various menus of the electronic device 5000, etc. In the implementations of the present application, the display unit 5040 is mainly used to display a display interface of various applications in the electronic device 5000 and objects such as text and pictures displayed in the display interface. The display unit 5040 can include a display panel 5041. The display panel 5041 can be configured in the form of a liquid crystal display (LCD), an organic light-emitting diode (OLED), etc.

The input unit 5050 can be used to receive information such as numbers or characters input by the user. The input unit 5050 can include a touch panel 5051 and another input device 5052. The touch panel 5051, also referred to as a touch screen, can collect a touch operation of the user on or near the touch panel 5051 (such as an operation on the touch panel 5051 or an operation near the touch panel 5051 performed by the user by using a finger, stylus, or any other suitable object or accessory).

For example, the touch panel 5051 can detect a touch operation of the user and detect signals generated by the touch operation, convert these signals into contact coordinates, send the contact coordinates to the processor 5010, and receive commands from the processor 5010 and execute the commands. In addition, the touch panel 5051 can be implemented in various types such as resistive, capacitive, infrared, and surface acoustic wave. The another input device 5052 can include, but is not limited to, one or more of a physical keyboard, a function button (e.g., a volume control button, and a power on/off button), a trackball, a mouse, or a joystick.

Certainly, the touch panel 5051 can cover the display panel 5041. When the touch panel 5051 detects the touch operation on or near the touch panel 5051, the touch panel 5051 transmits the touch operation to the processor 5010 to determine a type of a touch event, and then the processor 5010 provides corresponding visual output on the display panel 5041 based on the type of the touch event. Although in FIG. 5, the touch panel 5051 and the display panel 5041 serve as two independent components to implement input and output functions of the electronic device 5000, in some implementations, the touch panel 5051 and the display panel 5041 can be integrated to implement the input and output functions of the electronic device 5000.

The electronic device 5000 can further include one or more sensors, e.g., a pressure sensor, a gravity acceleration sensor, and a proximity light sensor. Certainly, according to needs in various applications, the above electronic device 5000 can further include another component such as a camera. Because these components are not key components used in the implementations of the present application, these components are not shown in FIG. 5 and will not be described in detail.

It can be understood by a person skilled in the art that FIG. 5 is only an example of the electronic device and does not constitute a limitation on the electronic device. The electronic device can include more or fewer components than those shown in the figure, and some components or different components can be combined.

For ease of description, the above parts are described by dividing the parts into modules (or units) according to function. Certainly, when the present application is implemented, a function of each module (or unit) can be implemented in one or more pieces of software or hardware.

Obviously, the above implementations are only examples for clear description and are not limitations on the implementations. For a person of ordinary skill in the art, changes or variations of other different forms can be made based on the above description. All implementations do not need to be and cannot be exhaustively listed herein. Obvious changes or variations derived therefrom are still within the protection scope of the present application.

What is claimed is:

1. A method, the method comprising:
performing area division on a target table to be processed based on a primary key column in the target table to obtain at least one target area;
determining a number of rows in each of the at least one target area;
determining a starting row offset value of each target area based on the number of rows corresponding to each of the at least one target area, the starting row offset value indicating a location of the target area; and
writing data of each target column group of at least one target column group in the target table and in each target area to a baseline sorted string table corresponding to the target column group based on the starting row offset value of each target area.

2. The method according to claim 1, wherein the performing area division on the target table to be processed based on the primary key column in the target table to obtain the at least one target area includes:
sampling data in the primary key column to obtain sample values, the data in the primary key column being sequentially sorted;
comparing adjacent sample values among the sample values respectively to obtain corresponding comparison results;
determining at least one data division row based on the comparison results; and
dividing the target table based on the at least one data division row to obtain the at least one target area.

3. The method according to claim 1, wherein the determining the starting row offset value of each target area based on the number of rows corresponding to each of the at least one target area includes:
for each target area and in an order of the at least one target area from top to bottom in the target table:
in response to the target area being a first one in the order, determining that the starting row offset value of the target area is a first starting value; and
in response to the target area being not the first one in the order, determining the starting row offset value of the target area based on a number of rows corresponding to each of all target areas before the target area and the first starting value.

4. The method according to claim 1, wherein the writing the data of each target column group of the at least one target column group in the target table and in each target area to the baseline sorted string table corresponding to the target column group based on the starting row offset value of each target area includes:
for each target area and by using a thread corresponding to the target area:
determining a number of the at least one target column group as an initial batch size;
writing the data of each target column group of the at least one target column group and in the target area to the corresponding baseline sorted string table based on the batch size and the starting row offset value of each target area;
in response to determining that data writing fails, obtaining a latest successful count of target column group whose data is successfully written;
determining a new batch size based on the batch size and the latest successful count; and
performing a data writing operation on a target column group whose data is not successfully written based on the new batch size.

5. The method according to claim 4, wherein the performing the data writing operation on the target column group whose data is not successfully written based on the new batch size includes:
iteratively performing following acts until it is determined that data writing is successful and there is no target column group whose data is not successfully written:
writing data of a remaining target column group and in the target area to the corresponding baseline sorted string table based on the starting row offset value of the target area and the new batch size, the remaining target column group being a target column group whose data is not successfully written;
in response to determining that data writing fails, obtaining an iteration latest successful count of target column groups whose data is successfully written, and determining an iteration new batch size based on the batch size and the latest successful count;
in response to determining that data writing is successful and there is a target column group whose data is not successfully written, updating the iteration new batch size based on a ratio; and
in response to determining that data writing is successful and there is no target column group whose data is not successfully written, determining that a data completion procedure is ended.

6. The method according to claim 5, wherein the determining the iteration new batch size based on the batch size and the latest successful count includes:
determining a product of the batch size and a weight; and
determining a greatest value between the product and the latest successful count as the new batch size.

7. The method according to claim 4, further comprising:
in response to determining that data writing fails, obtaining a sum of batch sizes corresponding to all threads; and
in response to the sum being not greater than a number of the threads, determining that a memory resource is insufficient, and ending a data completion procedure.

8. An electronic device, comprising:
one or more processors; and
one or more memory devices, the one or more memory devices, individually or collectively, having computer instructions stored thereon, the computer instructions, when executed by the one or more processors, enabling the one or more processors to, individually or collectively, perform actions including:
performing area division on a target table to be processed based on a primary key column in the target table to obtain at least one target area;
determining a number of rows in each of the at least one target area;
determining a starting row offset value of each target area based on the number of rows corresponding to each of the at least one target area, the starting row offset value indicating a location of the target area; and
writing data of each target column group of at least one target column group in the target table and in each target area to a baseline sorted string table corresponding to the target column group based on the starting row offset value of each target area.

9. The electronic device according to claim 8, wherein the performing area division on the target table to be processed based on the primary key column in the target table to obtain the at least one target area includes:
sampling data in the primary key column to obtain sample values, the data in the primary key column being sequentially sorted;
comparing adjacent sample values among the sample values respectively to obtain corresponding comparison results;
determining at least one data division row based on the comparison results; and
dividing the target table based on the at least one data division row to obtain the at least one target area.

10. The electronic device according to claim 8, wherein the determining the starting row offset value of each target area based on the number of rows corresponding to each of the at least one target area includes:
for each target area and in an order of the at least one target area from top to bottom in the target table:
in response to the target area being a first one in the order, determining that the starting row offset value of the target area is a first starting value; and
in response to the target area being not the first one in the order, determining the starting row offset value of the target area based on a number of rows corresponding to each of all target areas before the target area and the first starting value.

11. The electronic device according to claim 8, wherein the writing the data of each target column group of the at least one target column group in the target table and in each target area to the baseline sorted string table corresponding to the target column group based on the starting row offset value of each target area includes:
for each target area and by using a thread corresponding to the target area:
determining a number of the at least one target column group as an initial batch size;
writing the data of each target column group of the at least one target column group and in the target area to the corresponding baseline sorted string table based on the batch size and the starting row offset value of each target area;
in response to determining that data writing fails, obtaining a latest successful count of target column group whose data is successfully written;
determining a new batch size based on the batch size and the latest successful count; and
performing a data writing operation on a target column group whose data is not successfully written based on the new batch size.

12. The electronic device according to claim 11, wherein the performing the data writing operation on the target column group whose data is not successfully written based on the new batch size includes:
iteratively performing following acts until it is determined that data writing is successful and there is no target column group whose data is not successfully written:
writing data of a remaining target column group and in the target area to the corresponding baseline sorted string table based on the starting row offset value of the target area and the new batch size, the remaining target column group being a target column group whose data is not successfully written;
in response to determining that data writing fails, obtaining an iteration latest successful count of target column groups whose data is successfully written, and determining an iteration new batch size based on the batch size and the latest successful count;
in response to determining that data writing is successful and there is a target column group whose data is not successfully written, updating the iteration new batch size based on a ratio; and
in response to determining that data writing is successful and there is no target column group whose data is not successfully written, determining that a data completion procedure is ended.

13. The electronic device according to claim 12, wherein the determining the iteration new batch size based on the batch size and the latest successful count includes:
determining a product of the batch size and a weight; and
determining a greatest value between the product and the latest successful count as the new batch size.

14. The electronic device according to claim 11, wherein the actions include:
in response to determining that data writing fails, obtaining a sum of batch sizes corresponding to all threads; and
in response to the sum being not greater than a number of the threads, determining that a memory resource is insufficient, and ending a data completion procedure.

15. A storage medium, having computer instructions stored thereon, the computer instructions, when executed by one or more processors, enabling the one or more processors to, individually or collectively, implement actions comprising:
performing area division on a target table to be processed based on a primary key column in the target table to obtain at least one target area;
determining a number of rows in each of the at least one target area;
determining a starting row offset value of each target area based on the number of rows corresponding to each of the at least one target area, the starting row offset value indicating a location of the target area; and
writing data of each target column group of at least one target column group in the target table and in each target area to a baseline sorted string table corresponding to the target column group based on the starting row offset value of each target area.

16. The storage medium according to claim 15, wherein the performing area division on the target table to be processed based on the primary key column in the target table to obtain the at least one target area includes:
sampling data in the primary key column to obtain sample values, the data in the primary key column being sequentially sorted;
comparing adjacent sample values among the sample values respectively to obtain corresponding comparison results;
determining at least one data division row based on the comparison results; and
dividing the target table based on the at least one data division row to obtain the at least one target area.

17. The storage medium according to claim 15, wherein the determining the starting row offset value of each target area based on the number of rows corresponding to each of the at least one target area includes:
for each target area and in an order of the at least one target area from top to bottom in the target table:
in response to the target area being a first one in the order, determining that the starting row offset value of the target area is a first starting value; and
in response to the target area being not the first one in the order, determining the starting row offset value of the target area based on a number of rows corresponding to each of all target areas before the target area and the first starting value.

18. The storage medium according to claim 15, wherein the writing the data of each target column group of the at least one target column group in the target table and in each target area to the baseline sorted string table corresponding to the target column group based on the starting row offset value of each target area includes:
for each target area and by using a thread corresponding to the target area:
determining a number of the at least one target column group as an initial batch size;
writing the data of each target column group of the at least one target column group and in the target area to the corresponding baseline sorted string table based on the batch size and the starting row offset value of each target area;
in response to determining that data writing fails, obtaining a latest successful count of target column group whose data is successfully written;
determining a new batch size based on the batch size and the latest successful count; and
performing a data writing operation on a target column group whose data is not successfully written based on the new batch size.

19. The storage medium according to claim 18, wherein the performing the data writing operation on the target column group whose data is not successfully written based on the new batch size includes:
iteratively performing following acts until it is determined that data writing is successful and there is no target column group whose data is not successfully written:
writing data of a remaining target column group and in the target area to the corresponding baseline sorted string table based on the starting row offset value of the target area and the new batch size, the remaining target column group being a target column group whose data is not successfully written;
in response to determining that data writing fails, obtaining an iteration latest successful count of target column groups whose data is successfully written, and determining an iteration new batch size based on the batch size and the latest successful count;
in response to determining that data writing is successful and there is a target column group whose data is not successfully written, updating the iteration new batch size based on a ratio; and
in response to determining that data writing is successful and there is no target column group whose data is not successfully written, determining that a data completion procedure is ended.

20. The storage medium according to claim 19, wherein the determining the iteration new batch size based on the batch size and the latest successful count includes:
determining a product of the batch size and a weight; and
determining a greatest value between the product and the latest successful count as the new batch size.
